(19) United States
(12) Patent Application Publication
(10) Pub. No.: US 2021/0342496 A1
(43) Pub. Date: Nov. 4, 2021

(54) GEOMETRY-AWARE INTERACTIVE DESIGN

(71) Applicant: Hewlett-Packard Development Company, L.P., Spring, TX (US)

(72) Inventors: Keanu Phillip Spies, Palo Alto, CA (US); Jishang Wei, Guilford, CT (US); Refael Antonio Ballagas, Palo Alto, CA (US); Alxander Thayer, Palo Alto, CA (US)

(73) Assignee: Hewlett-Packard Development Company, L.P., Spring, TX (US)

(21) Appl. No.: 17/280,930

(22) PCT Filed: Nov. 26, 2018
(86) PCT No.: PCT/US2018/062466

§ 371 Date: Mar. 29, 2021

(51) Int. Cl. G06F 30/12; G06N 3/04; G06N 3/08

(52) U.S. Cl. CPC G06F 30/12; G06F 2111/04; G06N 3/088; G06N 3/0454

(57) ABSTRACT

Examples for geometry-aware interactive design are described herein. In some examples, a computing device may extract geometric information from an input image of an object. The computing device may generate an output image by a generator network based on the extracted geometric information, a latent space vector of the input image and a sketch input.

### BACKGROUND

Computing devices are used to perform a variety of tasks, including work activities, banking, research, and entertainment. In some examples, computing devices may be used to design objects. For instance, a user may use a computing device to generate images or models of an object.

### BRIEF DESCRIPTION OF THE DRAWINGS

Various examples will be described below by referring to the following figures.

FIG. 1 is an example block diagram of a computing device in which geometry-aware interactive design may be performed;

FIG. 2 is an example flow diagram illustrating a method for geometry-aware interactive design;

FIG. 3 is another example block diagram of a computing device in which geometry-aware interactive design may be performed;

FIG. 4 is an example flow diagram illustrating another method for geometry-aware interactive design; and

FIG. 5 is an example block diagram illustrating a user interface for geometry-aware interactive design.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Examples of a system to create a product/object design in real time based on a user's sketch input is described herein. In some approaches, adversarial networks are used to generate images from detailed sketches. However, in these approaches, detailed sketches are needed to be completely done to generate the desired image. Further, in these approaches the process of generating a desired image is static instead of dynamic.

In the examples described herein, a system may extract geometric information from an input image. A generator network may generate an output image based on the extracted geometric information, a latent space vector of an input example, and a sketch input. In some examples, a low-dimensional latent space vector may be selected starting with an input image on a sketch interface. The latent space vector may be concatenated with a geometric abstraction of the input image to generate the desired output image. Further, the system may measure a plurality of loss functions (e.g., shape and color constraints, real-ness loss, distance regulation loss and local identity loss) to determine the resemblance of the sketch with the output image. The system presents an intuitive and accessible sketching-based interface for realistic design results.

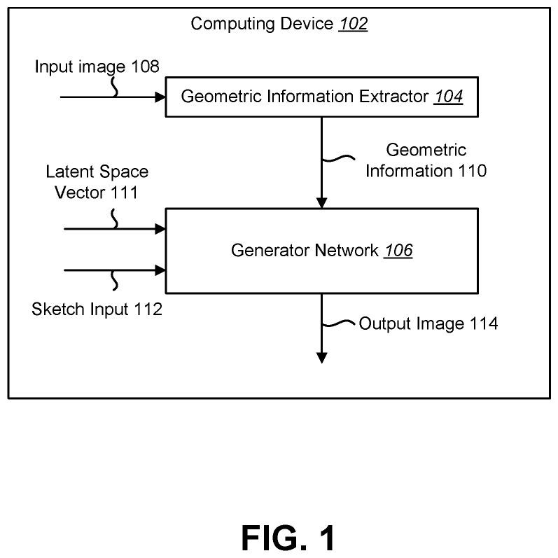

FIG. 1 is an example block diagram of a computing device 102 in which geometry-aware interactive design may be performed. Examples of computing devices 102 may include desktop computers, laptop computers, tablet devices, smart phones, cellular phones, game consoles, server devices, cameras, and/or smart appliances, etc. In other examples, the computing device 102 may be a distributed set of devices. For example, the computing device 102 may include multiple discrete devices organized in a system to implement the processes described herein. In some implementations, the computing device 102 may include and/or be coupled to a display for presenting information (e.g., images, text, graphical user interfaces (GUIs), etc.).

The computing device 102 may include a processor. The processor may be any of a central processing unit (CPU), a microcontroller unit (MCU), a semiconductor-based microprocessor, GPU, FPGA, an application-specific integrated circuit (ASIC), and/or other hardware devices suitable for retrieval and execution of instructions stored in the memory. The processor may fetch, decode, and execute instructions, stored on the memory and/or data storage, to implement geometry-aware interactive design.

The memory may include read only memory (ROM) and/or random access memory (RAM). The memory and the data storage may also be referred to as a machine-readable storage medium. A machine-readable storage medium may be any electronic, magnetic, optical, or other physical storage device that contains or stores executable instructions. Thus, the machine-readable storage medium may be, for example, RAM, EEPROM, a storage device, an optical disc, and the like. In some examples, the machine-readable storage medium may be a non-transitory machine-readable storage medium, where the term “non-transitory” does not encompass transitory propagating signals. The machine-readable storage medium may be encoded with instructions that are executable by the processor.

The computing device 102 may enable functionality for geometry-aware interactive design. For example, the computing device 102 may include hardware (e.g., circuitry and/or processor(s), etc.) and/or machine-executable instructions (e.g., program(s), code, and/or application(s), etc.) for geometry-aware interactive design. In some examples, the computing device 102 may include a user interface to capture a sketch input 112 and display an output image 114.

The computing device 102 may leverage artificial intelligence (Al) to create high-fidelity product and/or object designs in real time. The output image may be based on a user's sketched input. The computing device 102 may use a geometric prior to create high fidelity designs. In some examples, product designers would benefit from the ability to visualize their designs as a complete image in real time. Furthermore, the geometry-aware interactive design described herein may provide consumers with a way to communicate their desires to manufacturers.

Geometry-aware generative models for sketching-based experiential design are described herein. The computing device 102 may generate an output image 114 designed by integrating prior knowledge known for a group of objects and data-driven learned knowledge about various individual observations. Another aspect of the described geometry-aware interactive design is a sketching-based interface that enables experiential design using underlying geometry-aware models.

In some examples, the computing device 102 includes a geometric information extractor 104. The geometric information extractor 104 may be implemented as instructions stored in the memory that are executed by the processor.

The geometric information extractor 104 may extract geometric information 110 from an input image 108 of an object. In some examples, the input image 108 may be representative of a type of object. For example, if a user is designing a pair of sunglasses, the input image 108 may be an initial representation of sunglasses. In some examples, the initial input image 108 may be obtained from a training set (e.g., a set of images used to train the generator network 106). It should be noted that the input image 108 may also be obtained from a source other than the training set.

The geometric information extractor 104 may perform image processing to determine the geometric information 110. For example, the geometric information extractor 104 may perform shape segmentation to identify edges and/or contours of the object in the input image 108. The type of geometric information extraction method used to extract the geometric information 110 may be based on the type of object to be designed. For example, in the case of sunglasses design, the geometric information extractor 104 may use morphological active contours without edges (ACWE) to extract the geometric shape of the object (e.g., sunglasses) in the input image 108.

In the example of designing sunglasses, the shape of the rims of the object (which in this case is a pair of sunglasses) may be extracted from the input image 108 at timestep t. With sunglasses, the morphological ACWE segmentation may be an adaptive contour model that grows to fit along the rims of the sunglasses. For sunglasses, this may be a good judge of the shape since the frames will bend around the rims.

In some examples, the geometric information 110 may be in the form of a vector or matrix. For example, the geometric information extractor 104 may project the extracted geometric information 110 into a low dimensional geometric information vector. The extracted geometric information 110 may undergo a differentiable projection (e.g., phi) into a lower dimensional space that can be concatenated with the projected latent space vector of the input image. The concatenated vector may be provided to the generator network 106.

In some examples, the differentiable projection transforms geometric information 110 to a vector in the lower-dimensional space. The geometric information vector may be concatenated with the latent space vector 111. The differentiable projection may be referred to as a phi function. In an implementation, the phi function may be implemented as a fully-connected neural network trained through a training process. In some examples, the differentiable projection may be pre-trained before the geometry-aware interactive design is performed. As used herein, pre-training of a neural network before run-time operation of the geometry-aware interactive design may be referred to offline training. It should be noted that the differentiable projection may be implemented in other forms.

The computing device 102 may receive a sketch input 112. For example, the sketch input 112 may be captured by a user interface. The user interface may enable the user to interact directly with what is displayed by the computing device 102. Examples of a user interface to capture the sketch input 112 include touchscreens, touchpads, mouse, pointing stick, joystick, trackball, etc.

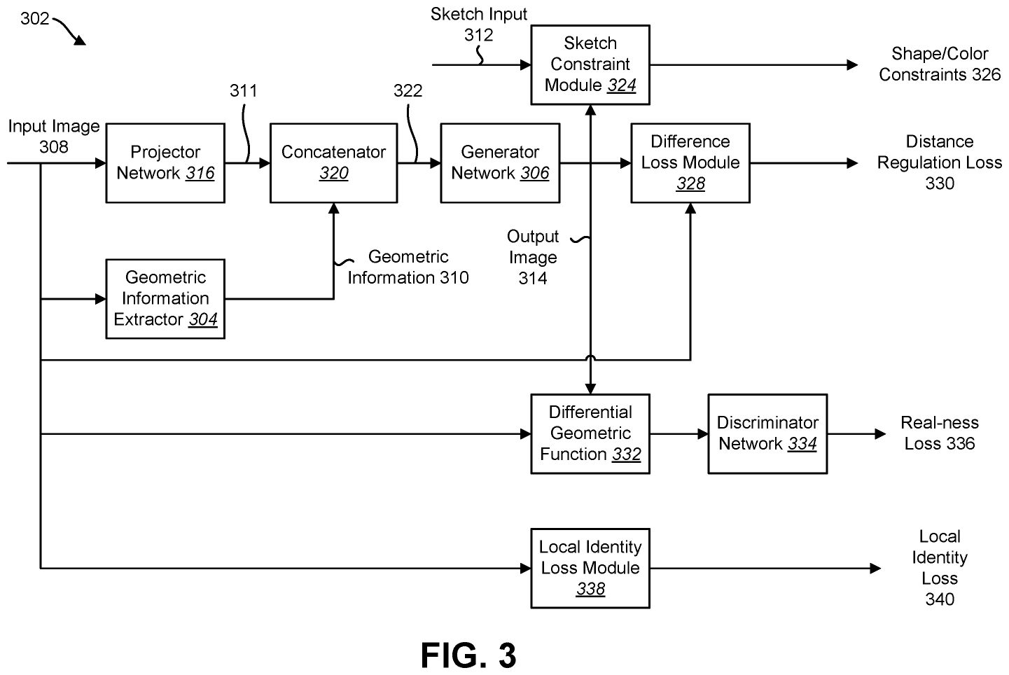

A generator network 106 may generate an output image 114 based on the extracted geometric information 110, the sketch input 112 and the latent space vector 111 representation of the input image 108. In some examples, the generator network 106 is a neural network (e.g., convolutional neural network). As used herein a network (e.g., neural network) may be implemented as instructions stored in the memory that are executed by the processor. The generator network 106 may be included in a generative adversarial network, which is described in more detail in connection with FIG. 3. The generator network 106 may be trained to create versions of the object in the input image 108.

In some examples, the generator network 106 may receive a latent space vector 111 representing the input image 108. The latent space vector 111 representation may be an encoded lower-dimensional representation vector (e.g., a 100-level representation) of an object. The generator network 106 may produce an output image 114 to signify what was encoded in that lower dimensional vector.

With knowledge of the shape provided by the geometric information 110 (also referred to as a shape prior), the generator network 106 is more able to generate the body of the object around the shape. In other words, the output image 114 may have a higher fidelity since the generator network 106 is more able to generalize to the object's specific shape(s).

The generator network 106 may merge the sketch input 112 with the input image 108 based on the geometric information 110 and the latent space vector 111 to produce an output image 114. For example, the generator network 106 may explore the concatenated vector of the latent space and geometric information 110 using a histogram of oriented gradients (HOG) or pixel-wise constraints for shape and color constraints respectively. This can be done through a series of gradient descent operations that move in the direction of the constraints.

In some examples, these constraints may be loss functions. A first loss function may include shape and color constraints. For example, the generator network 106 may attempt to constrain the generated output image 114 to have a similar shape/color given the sketch input 112.

A second loss function may include a real-ness loss. For example, given a generated output image 114, the real-ness may indicate how realistic the output image 114 seems given the training set.

A third loss function may include a distance regulation loss. For example, the generator network 106 may maintain a similar output to the design one timestep before the current timestep. In other words, the distance regulation loss may indicate how similar the output image 114 is to the input image 108.

A fourth loss function may include a local identity loss. For example, the local identity loss may ensure that the generated output image 114 follows some local constraint. The local constraint may be a geometric characteristic associated with the shape of the object. In the case of sunglasses, this local constraint is the symmetry along the vertical axis, which is identified by flipping the image in that plane and taking a L2 norm of the two mirror images. For non-symmetrical shapes, other local constraints unique to the shape of the object may be used.

When these loss functions are prescribed to a vector, the generator network 106 may create an output image 114 (e.g., a pair of sunglasses) that matches the idea that the user is sketching. Thus, an output image 114 of an object can be produced and edited according to the user's desires.

These loss functions may add complexity to the constraints that the user can edit. This may provide for finer tuning of the output image generation and better results from the system. Another benefit of this system is that the geometry of the generated output image 114 may be directly altered by changing the geometric prior added to the system. This acts as a latent space for geometric designs of the object.

The geometry-aware interactive design described herein may be a dynamic process. For example, the sketch input 112 may be received at a user interface that presents a number of different output images 114 generated based on the extracted geometric information 110, the latent space vector 111 and the sketch input 112. Multiple output images 114 may be generated and displayed in the user interface. The generator network 106 may generate a series of output images 114 by running the constraints (e.g., geometric information 110, sketch input 112 and loss functions) from multiple random initializations. This series of output images 114 may be displayed in the user interface.

The user may choose the best output image 114 to continue the geometry-aware interactive design. For example, the selected output image 114 may be used as the input image 108 for generating a subsequent output image 114 based on changes to the sketch input 112. In this manner, the system may use the user-selected output image 114 in a feedback loop for iterative generation of an output image 114.

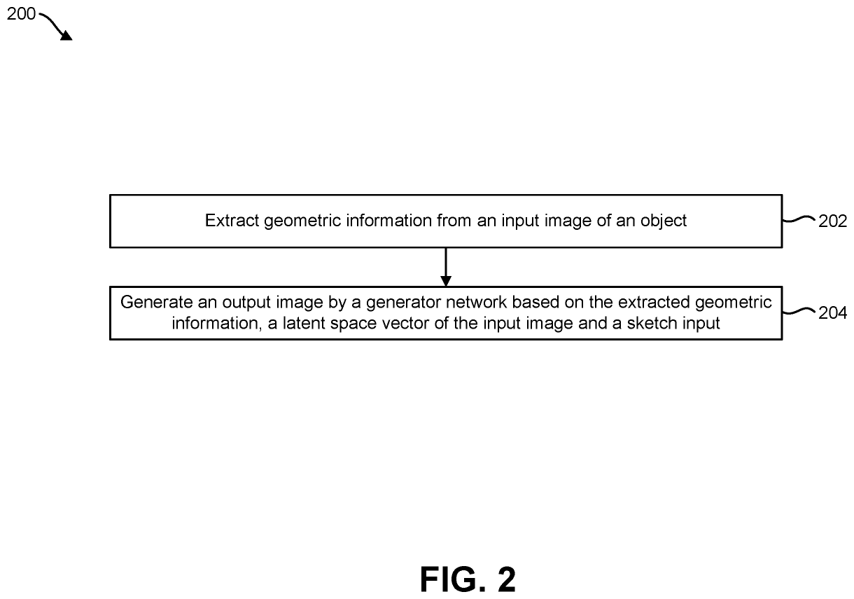

FIG. 2 is an example flow diagram illustrating a method 200 for geometry-aware interactive design. The computing device 102 may extract 202 geometric information 110 from an input image 108 of an object. For example, the type of geometric information extraction method used to extract the geometric information 110 may be based on the type of object to be designed. In some implementations, the computing device 102 may determine a morphological ACWE of the input image 108 of the object. In some examples, the computing device 102 may project the geometric information 110 into a low dimensional geometric information vector. The computing device 102 may then concatenate the low dimensional geometric information vector with a projected latent space vector 111 of the input image 108.

The computing device 102 may generate 204 an output image 114 by a generator network 106 based on the extracted geometric information 110, a latent space vector 111 of the input image 108 and a sketch input 112. The sketch input 112 may be received at a user interface. In some examples, the user interface may present a number of different output images 114 generated based on the extracted geometric information 110, the latent space vector 111 and the sketch input 112.

The computing device 102 may determine a real-ness loss based on a differentiable geometric function that maps the output image to a canonical shape of objects in a training set. The real-ness loss may be used as a constraint when generating the output image 114.

The computing device 102 may determine a local identity loss indicative of whether the output image follows a local constraint. The local identity loss may be used as a constraint when generating the output image 114.

The generator network 106 may generate 204 the output image 114 based on the concatenated vector and the sketch input 112. In some examples, the generator network 106 may explore the concatenated vector of the latent space and geometric information 110 using a histogram of oriented gradients (HOG) or pixel-wise constraints for shape and color constraints respectively. This can be done through a series of gradient descent operations that move in the direction of the constraints (e.g., the real-ness loss and/or the local identity loss).

FIG. 3 is another example block diagram of a computing device 302 in which geometry-aware interactive design may be performed. The computing device 302 may be an example of the computing device 102 described in connection with FIG. 1 in some implementations.

The computing device 302 may include an interactive generative adversarial network. In some examples, the interactive generative adversarial network may include a projector network 316 (also referred to as a projector), a generator network 306 (also referred to as a generator) and a discriminator network 334 (also referred to as a discriminator).

The projector network 316 is a neural network that acts an encoder from the image space to the latent space representation of an object category. This is the antithesis to the generator network 306 and the two will act as an encoder-decoder network. The projector network 316 may be trained to encode the input image 308 into a latent space vector 311 representation. In some examples, the latent space representation may be an encoded lower-dimensional representation vector (e.g., a 100-level representation), of an object. As used herein, latent space may include multiple dimensions in which each point on a specific manifold, learnt through training examples, would correspond to an object in the two-dimensional image space.

In some examples, the generator network 306 may be a neural network. The generator network 306 may receive a latent space representation of the input image 308. The generator network 306 may produce an output image 314 to signify what was encoded in that lower dimensional vector.

The discriminator network 334 may take the output image 314 and decide whether the output image 314 is likely to be in the distribution of the target object class or criteria. In an example of an image of a pair of generated sunglasses, the discriminator network 334 may determine if the generated output image 314 appears as a pair of sunglasses based on the training data. For example, the discriminator network 334 may indicate a “0” if the output image 314 is likely to be a pair of sunglasses and “1” if the output image 314 is not likely to be a pair of sunglasses.

In some examples, the projector network 316, the generator network 306 and the discriminator network 334 may be trained using a common training dataset. The training of the projector network 316, the generator network 306 and the discriminator network 334 may occur offline. The projector network 316, the generator network 306 and the discriminator network 334 may be trained for different object types. For example, the projector network 316, the generator network 306 and the discriminator network 334 may be trained for different types of objects that a user may wish to design.

A geometric information extractor 304 may extract geometric information 310 from the input image 308. For example, the geometric information extractor 304 may perform shape segmentation to identify edges and/or contours of the object in the input image 308. In some examples, the geometric information extractor 304 may use morphological active contours without edges (ACWE) to extract the geometric shape of the object in the input image 308.

In some examples, the geometric information 310 may be in the form of a vector or matrix. For example, the geometric information extractor 304 may project the extracted geometric information 310 into a low dimensional geometric information vector. The extracted geometric information 310 may undergo a differentiable projection (e.g., phi) into a lower dimensional space.

A concatenator 320 may concatenate the low dimensional geometric information vector 310 with the projected latent space vector 311 of the input image 308. The concatenated vector 322 (also referred to as a shape projection) may be provided to the generator network 306.

The generator network 306 may generate the output image 314 based on the concatenated vector 322, the sketch input 312 and a plurality of constraints. In some examples, the constraints used to guide the generation of the output image 314 may be loss functions. For example, a sketch constraint module 324 may determine a shape/color constraint 326. Given a sketch input 312, the sketch constraint module 324 may attempt to constrain the generated output of the generator network 306 to have a similar shape/color as the sketch input 312. The sketch constraint module 324 may use a histogram of oriented gradients (HOG) or pixel-wise constraints for shape and color constraints respectively to merge the sketch input 312 and the output image 314. This can be done through a series of gradient descent operations that move in the direction of the constraints.

The real-ness loss 336 may be a loss function that indicates how realistic the output image 314 is given the training set for the discriminator network 334. In this case, the discriminator network 334 does not directly see the generation of the output image 314. Instead, the discriminator network 334 receives an output of a differentiable geometric function 332 that maps the object to its canonical shape such that it can be compared to objects in the dataset accurately. The differentiable geometric function 332 may be a process that extracts geometric information. The discriminator network 334, implemented as a neural network, may differentiate the geometric information from the output of a generator network 306 to that from a real image with the canonical shape.

A difference loss module 328 may determine a distance regulation loss 330 based on the input image 308 and the output image 314. The distance regulation loss 330 may be used to maintain a similar output to the design one timestep before the current timestep. For example, the distance regulation loss 330 may indicate how similar the output image 314 is to the input image 308.

A local identity loss module 338 may determine a local identity loss 340. For example, the local identity loss module 338 may ensure that the generated output image 314 follows a local constraint associated with the object that is being designed. In some cases, the local constraint may be symmetry along a given axis. For non-symmetrical shapes, other local constraints unique to the shape of the object may be used.

The generator network 306 may generate the output images 314 based on the shape/color constraint 326, the distance regulation loss 330, the real-ness loss 336 and/or the local identity loss 340. For example, the shape/color constraint 326, the distance regulation loss 330, the real-ness loss 336 and/or the local identity loss 340 may be fed back (e.g., input) to the generator network 306. The generator network 306 may modify the output image 314 to minimize the loss associated with the constraints. For example, the generator network 306 may iteratively modify the output image 314 to minimize the values of the shape/color constraint 326, the distance regulation loss 330, the real-ness loss 336 and/or the local identity loss 340. It should be noted that the real-ness loss 336 and the local identity loss 340 may be used to ensure geometric conformity of the output image 314 to the input image 308.

In some examples, the geometric information 310 (also referred to as the geometric prior) may be used for sketching-based generative models applied to two-dimensional (2D) or three-dimensional (3D) design. For example, the generator network 306 may generate a 2D output image 314 based on the sketch input 312. In other examples, the generator network 306 may generate a 3D output image 314. This may include a 3D model. The 3D content design may be used in 3D printing applications, virtual reality, augmented reality, gaming, etc.

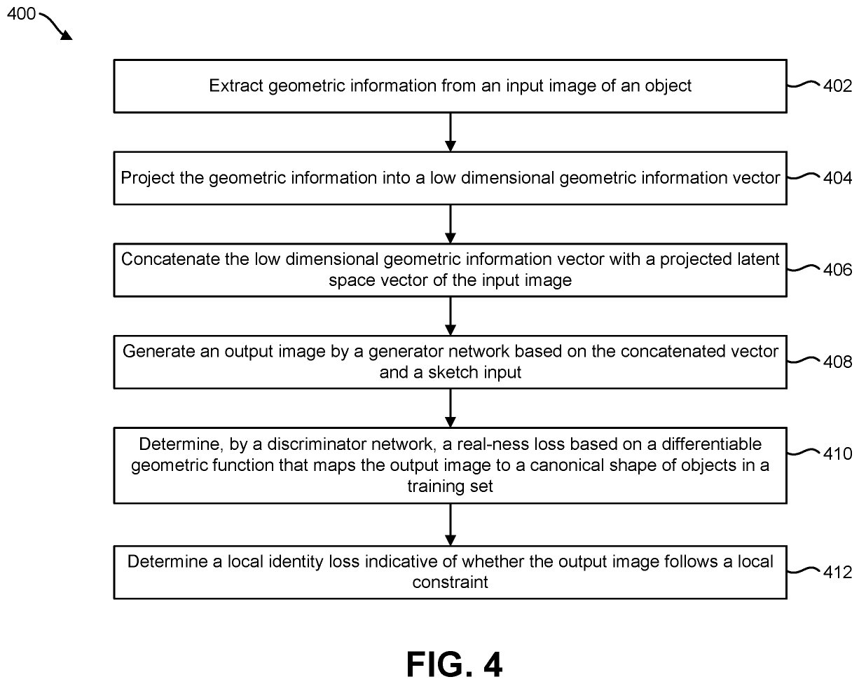

FIG. 4 is an example flow diagram illustrating another method 400 for geometry-aware interactive design. The computing device 302 may extract 402 geometric information 310 from an input image 308 of an object. For example, the computing device 302 may determine a morphological ACWE of the input image 308 of the object.

The computing device 302 may project 404 the geometric information 310 into a low dimensional geometric information vector. For example, the extracted geometric information 310 may undergo a differentiable projection (e.g., phi) into a lower dimensional space.

The computing device 302 may concatenate 406 the low dimensional geometric information vector with a projected latent space vector of the input image 308. For example, a projector network 316 may encode the input image 308 from the image space to the latent space representation of an object category. The projector network 316 may be trained to encode the input image 308 into a latent space vector 311 representation. In some examples, the latent space representation may be an encoded lower-dimensional representation vector (e.g., a 100-level representation), of an object. The low dimensional geometric information vector 310 may be concatenated with the projected latent space vector 311 generated by the projector network 316 to produce a concatenated vector 322.

The computing device 302 may generate 408 an output image 314 by a generator network 306 based on the concatenated vector 322 and a sketch input 312. The sketch input 312 may be received at a user interface. In some examples, the generator network 306 may explore the concatenated vector 322 of the latent space and geometric information 310 using a histogram of oriented gradients (HOG) or pixel-wise constraints for shape and color constraints respectively. This can be done through a series of gradient descent operations that move in the direction of the constraints.

The computing device 302 may determine 410, by a discriminator network 334, a real-ness loss 336. The real-ness loss 336 may be a loss function that indicates how realistic the output image 314 is given the training set for the discriminator network 334. The real-ness loss 336 may be based on a differentiable geometric function 332 that maps the output image 314 to a canonical shape of objects in a training set. The real-ness loss 336 may be used as a constraint when generating 408 the output image 314.

The computing device 302 may determine 412 a local identity loss 340 indicative of whether the output image 314 follows a local constraint. For example, the local identity loss 340 may ensure that the generated output image 314 follows a local constraint. In some examples, the local constraint may be associated with the shape of the designed object. In the case of sunglasses, this local constraint is the symmetry along the vertical axis which is identified by flipping the image in that plane and taking a L2 norm of the two mirror images. For non-symmetrical shapes, other local constraints unique to the shape of the object may be used. The local identity loss 340 may be used as a constraint when generating 408 the output image 314.

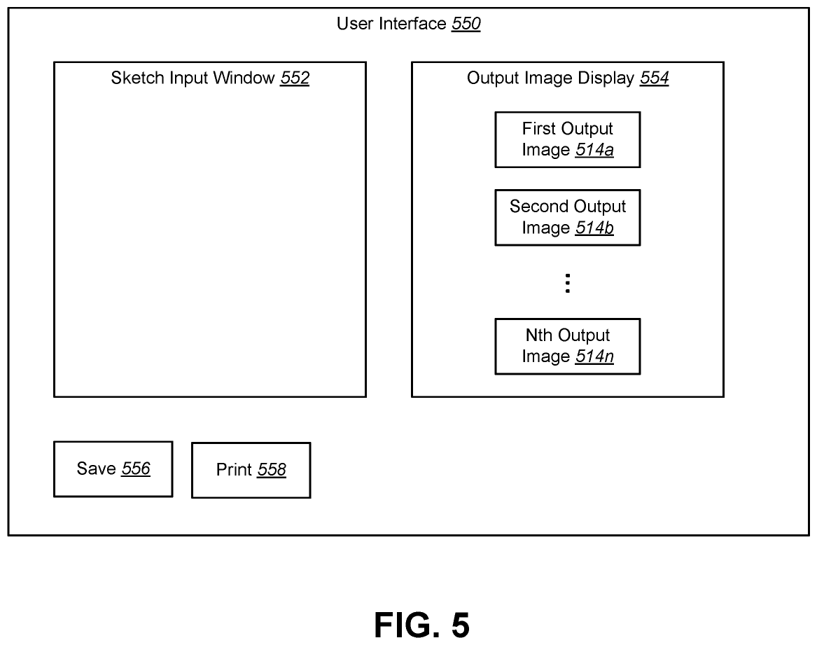

FIG. 5 is an example block diagram illustrating a user interface 550 for geometry-aware interactive design. The user interface 550 may include a sketch input window 552 and an output image display 554. The sketch input window 552 (also referred to as a drawing pad) may display a sketch input created by a user. In some examples, the user may directly sketch in the sketch input window 552. For example, the sketch input window 552 may be displayed on a touchscreen upon which a user sketches. In other examples, the user may interact with another user interface device (e.g., mouse, touchpad, etc.) to provide a sketch input.

The output image display 554 may display a number of output images 514a-n. When the user begins sketching on the sketch input window 552, the system runs the sketch input through the pre-trained offline model to produce suggested results that are displayed in the output image display 554. The output images 514a-n may be generated as described in connection with FIGS. 1-4. The system may recommend the series of generated images 514a-n to the user by running the sketch input constraint from multiple random initializations.

The user may choose an output image 514 to continue the geometry-aware interactive design. For example, the user may review the output images 514a-n to determine which output image 514 best matches the user's intended design. The user may select (e.g., click) the selected output image 514.

In some examples, the selected output image 514 may be used as the input image 108 for generating a subsequent output image 514 based on changes to the sketch input 112. For example, upon selecting an output image 514, the system may extract geometric information 110 from the selected output image 514 to be used for generating subsequent output images 514 based on changes to the sketch input 112. In this manner, the system may use the user-selected output image 514 in a feedback loop for iterative generation of an output image(s) 514.

The user interface 550 may also include additional user-selectable elements to interact with the generated output images 514. For example, the user interface 550 may include a save button 556 to save a selected output image 514. The user interface 550 may include a print button 558 to print the selected output image 514.

In some examples, a model for the designed object may be pretrained. For instance, the generator network 106 may be pre-trained with a training dataset for a given object type. Because the system is pretrained, the user interface 550 may work in real time to present output images 514a-n to the user as the user sketches.

1. A method, comprising:
extracting geometric information from an input image of an object; and
generating an output image by a generator network based on the extracted geometric information, a latent space vector of the input image and a sketch input.

2. The method of claim 1, wherein the geometric information is extracted based on a type of object being designed.

3. The method of claim 1, wherein extracting the geometric information comprises:
determining a morphological active contours without edges (ACWE) of the input image of the object.

4. The method of claim 1, further comprising:
projecting the geometric information into a low dimensional geometric information vector;
concatenating the low dimensional geometric information vector with the latent space vector of the input image; and
generating the output image by the generator network based on the concatenated vector and the sketch input.

5. The method of claim 1, wherein the sketch input is received at a user interface that presents different output images generated based on the extracted geometric information, the latent space vector and the sketch input.

6. The method of claim 1, wherein the output image is used as the input image for generating a subsequent output image based on changes to the sketch input.

7. A computing device, comprising:
a memory;
a processor coupled to the memory, wherein the processor is to:
receive a sketch input at a user interface;
extract geometric information from an input image of an object;
encode the input image into a latent space vector; and
generate an output image by a generator network based on the extracted geometric information, the latent space vector of the input image and the sketch input.

8. The computing device of claim 7, wherein the processor is to determine, by a discriminator network, a real-ness loss based on a differentiable geometric function, wherein the real-ness loss is used as a constraint when generating the output image.

9. The computing device of claim 8, wherein the differentiable geometric function maps the output image to a canonical shape of objects in a training set.

10. The computing device of claim 7, wherein the processor is to determine a local identity loss indicative of whether the output image follows a local constraint, wherein the local identity loss is used as a constraint when generating the output image.

11. The computing device of claim 10, wherein the local constraint comprises a geometric characteristic associated with a shape of the object.

12. The computing device of claim 7, wherein the processor is to modify, by the generator network, the output image to minimize a real-ness loss and a local identity loss.

13. The computing device of claim 12, wherein the real-ness loss and the local identity loss are used to ensure geometric conformity of the output image to the input image.

14. A non-transitory machine-readable storage medium encoded with instructions executable by a processor, the machine-readable storage medium comprising:
instructions to extract geometric information from an input image of an object;
instructions to project the geometric information into a low dimensional geometric information vector;
instructions to concatenate the low dimensional geometric information vector with a latent space vector of the input image; and
instructions to generate an output image by a generator network based on the concatenated vector and a sketch input.

15. The machine-readable storage medium of claim 14, further comprising:
instructions to determine, by a discriminator network, a real-ness loss based on a differentiable geometric function that maps the output image to a canonical shape of objects in a training set;
instructions to determine a local identity loss indicative of whether the output image follows a local constraint associated with a shape of the object; and
instructions to modify, by the generator network, the output image to minimize the real-ness loss and the local identity loss.
